(19) United States
(12) Patent Application Publication
(10) Pub. No.: US 2014/0132514 A1
(43) Pub. Date: May 15, 2014

(54) Portable Electronic Device With Dual Opposing Displays

(71) Applicants: Byron S. Kuzara, Portland, OR (US); Farnaz D. Fakhari, Portland, OR (US)

(72) Inventors: Byron S. Kuzara, Portland, OR (US); Farnaz D. Fakhari, Portland, OR (US)

(21) Appl. No.: 14/108,948

(22) Filed: Dec. 17, 2013

(51) Int. Cl. G06F 3/0346; G06F 3/023

(52) U.S. Cl. CPC G06F 3/0346; G06F 3/0233
USPC 345/158; 345/169

(57) ABSTRACT

A portable electronic device may include a first exterior side and a second exterior side. The first exterior side has a first display that renders a virtual keyboard. The second exterior side is located opposite the first exterior side and has a second display and a physical keyboard. The first display and the physical keyboard may be alternately and oppositely disabled and enabled in response to a reorientation signal.

### BACKGROUND

Portable electronic devices generally include portable multifunction devices, portable communication devices, and hand-held electronic devices. As examples, portable electronic devices may be various hand-held computers, tablet computers, mobile phones, smartphones, personal digital assistants, e-book readers, media players, or hand-held gaming devices, for example.

In order to provide a user with the ability to input characters (e.g., text, numbers, punctuation, symbols), portable electronic devices incorporate either a physical keyboard or a virtual keyboard. A physical keyboard includes a plurality of keys that the user depresses to input characters. Each of the keys are physical items that move or depress in response to contact with fingers of the user. An example of a portable electronic device that includes a physical keyboard is the BLACKBERRY (a trademark of Research In Motion, Inc.) smartphone. A virtual keyboard is rendered on a touch-sensitive display, also referred to as a touch screen, and includes images of various keys that the user contacts to input characters. In other words, the user touches the display in areas corresponding with the keys to input characters. An example of a portable electronic device that includes a virtual keyboard is the IPHONE (a trademark of Apple, Inc.) smartphone.

Physical keyboards have an advantage of providing tactile feedback for the user. More particularly, the user senses individual keys upon contact with the fingers, thereby providing the user with information regarding the relative positions of the keys and whether a particular key is depressed or otherwise activated. In comparison with virtual keyboards, the tactile feedback of physical keyboards may permit quicker and more accurate character input.

Virtual keyboards have an advantage of permitting portable electronic devices to include relatively large displays. That is, the display of a portable electronic device with a virtual keyboard may extend through a substantial majority of a length and width of the portable electronic device. When the portable electronic device is utilized for functions other than character input, the virtual keyboard disappears and the entire display is available for the other functions. For example, the entire display may be utilized for web browsing, reading email, viewing photos or video, or playing games. In contrast, the display of a portable electronic device with a physical keyboard is relatively small because the display and physical keyboard occupy separate spaces on one side of the portable electronic device.

### SUMMARY

A portable electronic device may include a first exterior side and a second exterior side. The first exterior side may have a first display that renders a virtual keyboard. The second exterior side is located opposite the first exterior side, and the second exterior side may have a second display and a physical keyboard. In addition, the first display and the physical keyboard may be alternately and oppositely disabled and enabled in response to a reorientation signal.

A method may include rendering an image that has a character field on a first display of a portable electronic device. A reorientation signal indicating an orientation change of the portable electronic device may be received. In addition, the method may include responding to the reorientation signal by rendering at least a portion of the image that includes the character field on a second display of the portable electronic device, the second display being located (a) on an opposite side of the portable electronic device relative to the first display and (b) adjacent to a physical keyboard.

The advantages and features of novelty characterizing aspects of a portable electronic device are pointed out with particularity in the appended claims. To gain an improved understanding of the advantages and features of novelty, however, reference may be made to the following descriptive matter and accompanying Figures that describe and illustrate various configurations and concepts related to the portable electronic device.

### FIGURE DESCRIPTIONS

FIGS. 1A and 1B are plan views of opposite sides of a portable electronic device.

FIGS. 2A-2K are plan views of the portable electronic device illustrating a method for character input.

FIG. 3A is a flow diagram illustrating various aspects of the portable electronic device.

FIG. 3B is a block diagram illustrating various aspects of the portable electronic device.

FIG. 4 is a plan view corresponding with FIG. 1B and depicting another configuration of the portable electronic device.

FIGS. 5A and 5B are plan views of opposite sides of another configuration of the portable electronic device.

FIGS. 6A and 6B are plan views of opposite sides of a further configuration of the portable electronic device.

FIGS. 7A and 7B illustrate a portion of a method for character input using the configuration of the portable electronic device depicted in FIGS. 6A and 6B.

### DETAILED DESCRIPTION

### Introduction

The following discussion and accompanying Figures disclose various configurations of portable electronic devices. Numerous specific details of the portable electronic devices are set forth in order to provide a thorough understanding of the concepts being presented. The portable electronic devices may, however, be produced without one or more of these specific details. In other instances, well-known methods, procedures, components, circuits, and networks are not described in detail to prevent unnecessarily obscuring various aspects of the portable electronic devices discussed below.

Terminology used in the following discussion is for the purpose of describing exemplary configurations of portable electronic devices only, and is not intended to be limiting. As an example, although the terms “first” and “second” may be used herein to describe elements, such as a first side and a second side of a portable electronic device, these terms should not be viewed as implying an order or hierarchy among the elements. Rather, these terms are used only to distinguish one element from another element. As another example, the term “comprising” specifies the presence of stated features, steps, operations, elements, or components, but does not preclude the presence or addition of one or more other features, steps, operations, elements, components, or groups thereof.

The portable electronic device configurations discussed below include examples of smartphones and tablet computers. Concepts discussed in relation to the smartphones and tablet computers may be applied to various other types of portable electronic devices, including hand-held computers, mobile phones, personal digital assistants, e-book readers, media players, and hand-held gaming devices. That is, the concepts presented below apply to a wide variety of devices and are discussed in relation to smartphones and tablet computers only for purposes of example.

A portable electronic device may support a variety of applications, such as a telephone application, a video conferencing application, an e-mail application, an instant messaging application, a web browsing application, a digital music player application, a digital camera application, a clock and alarm application, a calendar application, a notes application, a reminder application, a voice assistant application, a game application, an application that provides a marketplace for purchasing or downloading other applications, and a system settings application. The various applications supported by the portable electronic device may use at least one common user-interface device, such as a touch-sensitive display. One or more functions of the touch-sensitive display may support the variety of applications with user interfaces that are intuitive and transparent. Other examples of user interfaces include a physical keyboard or, as discussed below, a combination of a touch-sensitive display and a physical keyboard.

Portable Electronic Device

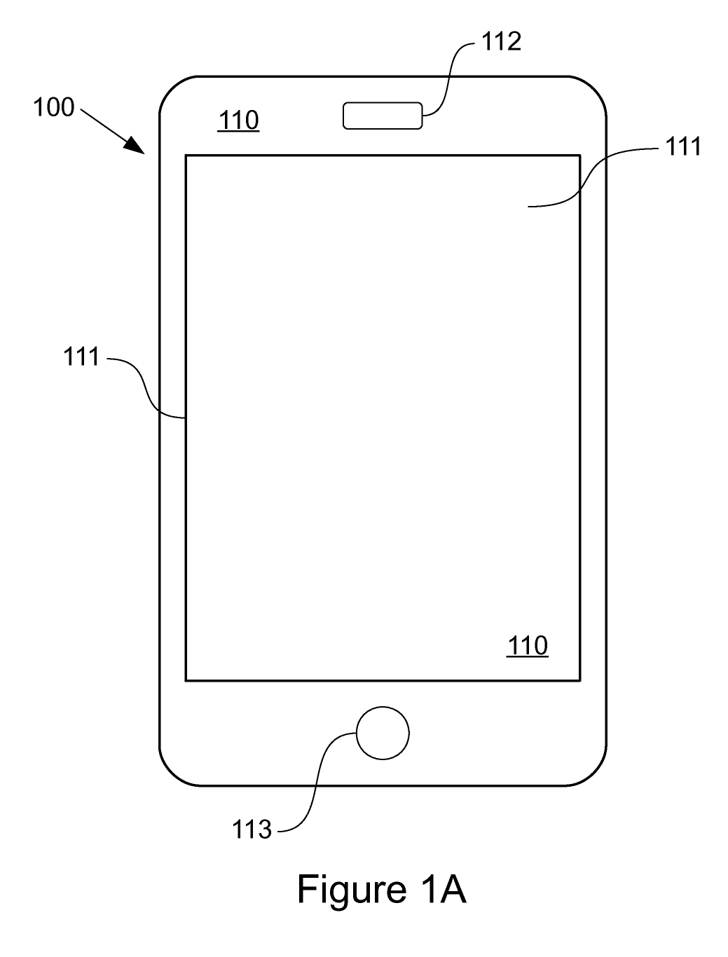

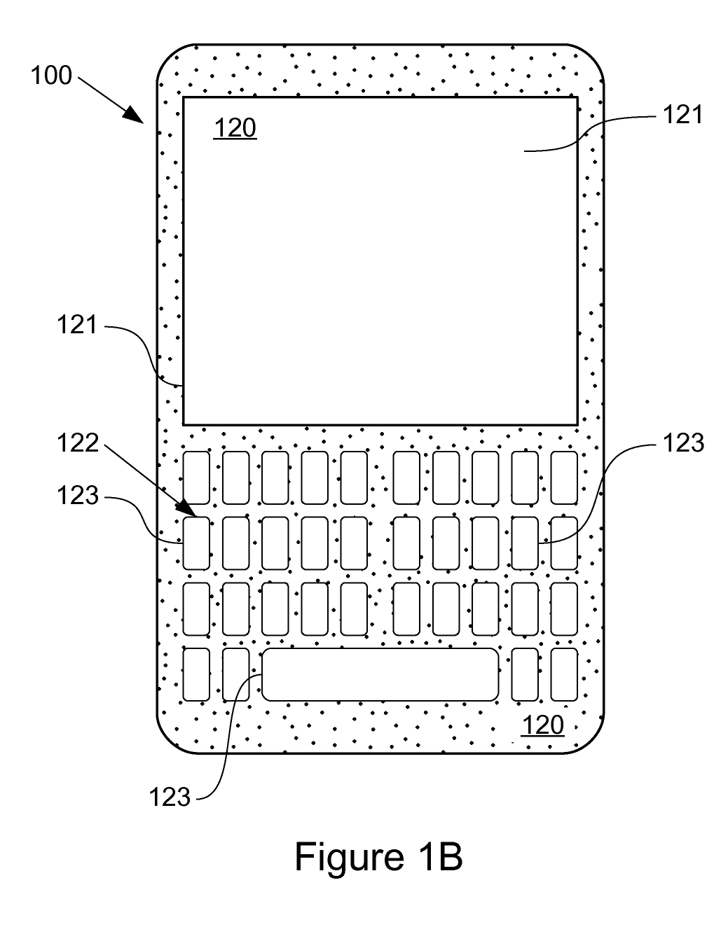

A first example of a portable electronic device 100 is illustrated in FIGS. 1A and 1B as having a configuration of a smartphone. Whereas FIG. 1A depicts a first side 110 of portable electronic device 100, FIG. 1B depicts a second side 120 of portable electronic device 100. Throughout various Figures, portions of second side 120 are depicted as having a stippled (i.e., speckled or dotted) texture in order assist the reader with visually-distinguishing between sides 110 and 120. First side 110 is located opposite second side 120, and each of sides 110 and 120 form a portion of an exterior of portable electronic device 100. As an analogy, first side 110 is like a front cover of an unopened book, and second side 120 is like a back cover of the book. After viewing first side 110, a user may turn portable electronic device 100 over (i.e., rotate portable electronic device 100 through approximately 180 degrees about an axis passing between and parallel to sides 110 and 120) in order to view second side 120. Similarly, after viewing second side 120, the user may turn portable electronic device 100 over in order to view first side 110. The user may, therefore, freely switch between sides 110 and 120 to utilize various functions of portable electronic device 100.

First side 110 includes a touch-sensitive display 111, a speaker 112, and an activation button 113. Touch-sensitive display 111 may render various images, such as a virtual keyboard, a text block, a character field, or a photo. In addition, touch-sensitive display 111 may register touch input that directs portable electronic device 100 to perform various functions. As an example, the user may touch or otherwise contact areas of touch-sensitive display 111 to input characters with a virtual keyboard, move an image, or change between two applications. Further details regarding features or functions of touch-sensitive displays and virtual keyboards may be found with reference to U.S. Pat. No. 7,694,231 to Kocienda, et al., which issued on 6 Apr. 2010 and is entitled “Keyboards For Portable Electronic Devices,” such patent being entirely incorporated herein by reference. Speaker 112 may produce sound during the course of a telephone conversation, for example. Activation button 113 is a single physical key that the user may depress to activate a function, such as exiting an application and returning to a home or primary screen on touch-sensitive display 111.

Second side 120 includes a display 121 and a physical keyboard 122. As with touch-sensitive display 111, display 121 may render various images, such as a text block, a character field, or a photo. In some configurations, display 121 may also be a touch-sensitive display. Physical keyboard 122 is positioned adjacent to display 121 and includes a plurality of keys 123 that the user contacts or depresses to input characters or perform other functions. Each of keys 123 are physical items that move or depress inward (i.e., toward first side 110) in response to contact with fingers of the user. Further details regarding the features or function of physical keyboards may be found with reference to U.S. Pat. No. 7,634,080 to Zhao, et al., which issued on 15 Dec. 2009 and is entitled “Multifunctional Keyboard For A Mobile Communication Device And Method for Operating The Same,” such patent being entirely incorporated herein by reference. In many configurations, physical keyboard 122 will include at least ten of keys 123 (e.g., number keys that are each assigned multiple letters) or at least thirty-six of keys 123 (e.g., each number and letter being assigned a separate key), but may include a greater or lesser number of keys 123 in other configurations.

Although not depicted, first side 110, second side 120, or an edge area of portable electronic device 100 may include various input and output elements, such as a power button, a headphone jack, a mute switch, one or more volume buttons, another speaker, a microphone, a power or data jack, a camera, a flash-type light source, one or more supplemental buttons, or a SIM card tray, for example. Moreover, examples of (a) additional features of portable electronic devices, (b) the architecture or design of portable electronic devices, and (c) various hardware or electronic elements that may be incorporated into portable electronic devices are disclosed in U.S. Pat. No. 8,223,134 to Forstall, et al., which issued on 17 Jul. 2012 and is entitled “Portable Electronic Device, Method, And Graphical User Interface For Displaying Electronic Lists And Documents,” such patent being entirely incorporated herein by reference.

Based upon the discussion above, portable electronic device 100 includes two opposite surfaces: first side 110 and second side 120. Whereas first side 110 includes touch-sensitive display 111, upon which a virtual keyboard may be rendered, second side 120 includes both display 121 and physical keyboard 122. Touch-sensitive display 111 extends through a substantial majority of a length and width of portable electronic device 100 and is, therefore, relatively large. Display 121 extends through less than half of the length of portable electronic device 100 to provide an area for physical keyboard 122 to reside. In comparison with touch-sensitive display 111, therefore, display 121 is relatively small. As discussed in greater detail below, this arrangement permits the user of portable electronic device 100 to choose between two modes for inputting characters: (a) a first mode in which a virtual keyboard is rendered on touch-sensitive display 111 or (b) a second mode utilizing physical keyboard 122. Moreover, the user may freely switch between these modes based upon preference, convenience, considerations relating to character input speed or tactile feedback, or various other factors.

As an additional matter, portable electronic device 100 is unique for efficient use of exterior surface area. As the size of electronic devices decreased over time, the exterior surface area available for display, input, and output elements also decreased. Despite this trend toward smaller devices, many conventional portable electronic devices make use of less than forty percent of exterior surface area for displays, keyboards, buttons, jacks, switches, speakers, microphones, cameras, light sources, and trays, for example. Moreover, back sides of many conventional smartphones are only utilized for cameras and light sources, trademarks, other manufacturer information, and regulatory symbols. In portable electronic device 100, however, a majority of both of sides 110 and 120 are utilized for display, input, and output elements. Although the proportions of these elements in portable electronic device 100 may vary, this configuration permits use of sixty to eighty percent or more of the exterior surface area for the display, input, and output elements. Accordingly, portable electronic device 100 is more efficient in use of exterior surface area than many conventional portable electronic devices.

Exemplary Process for Use

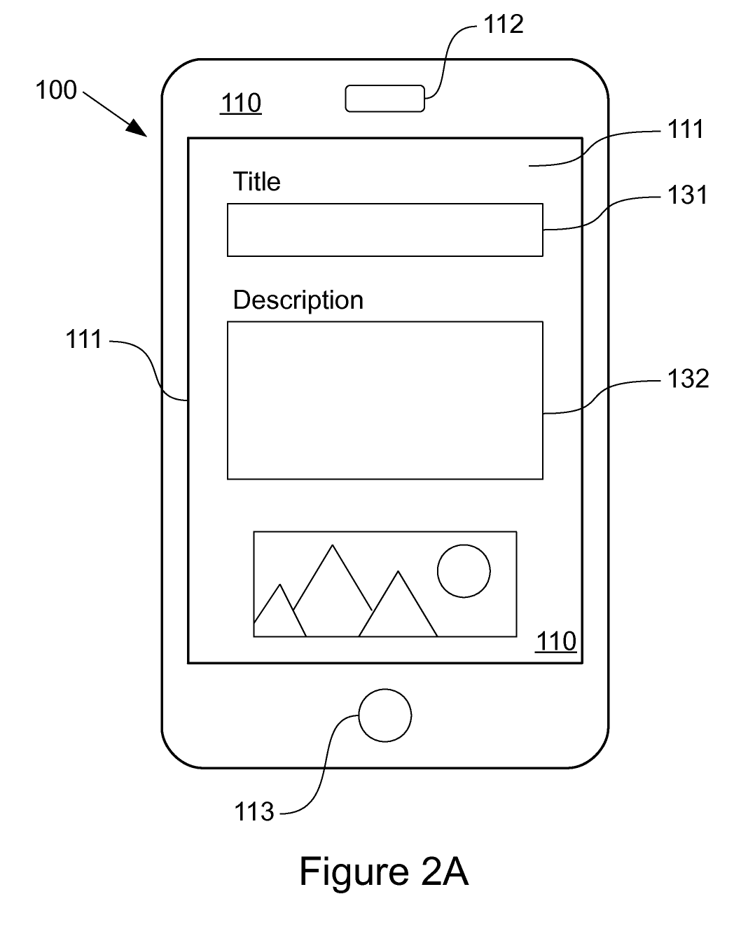

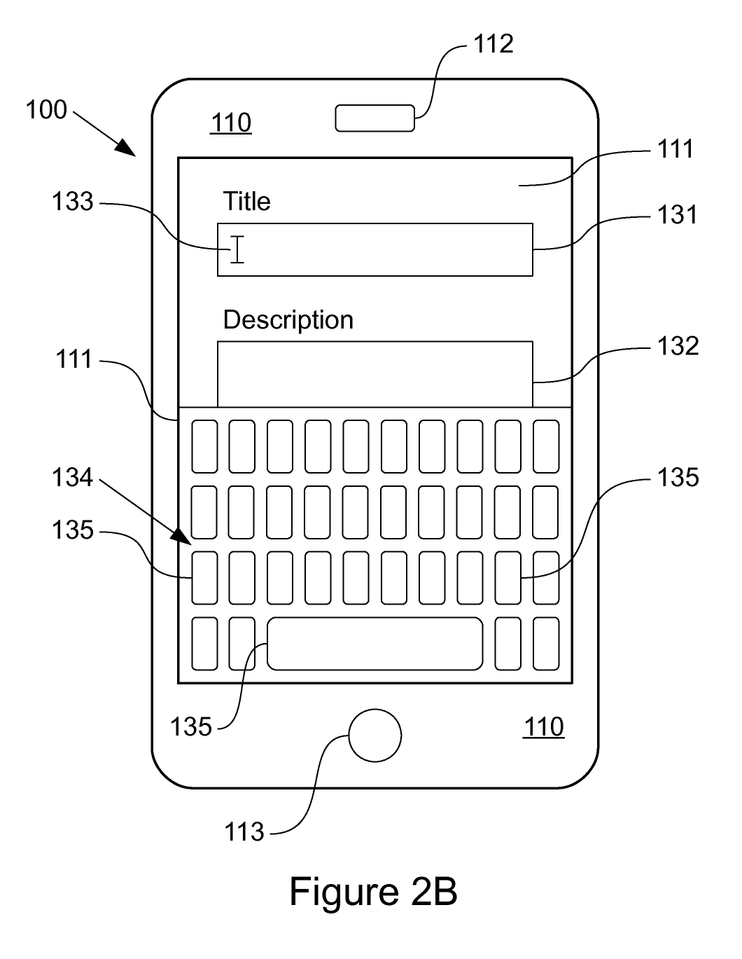

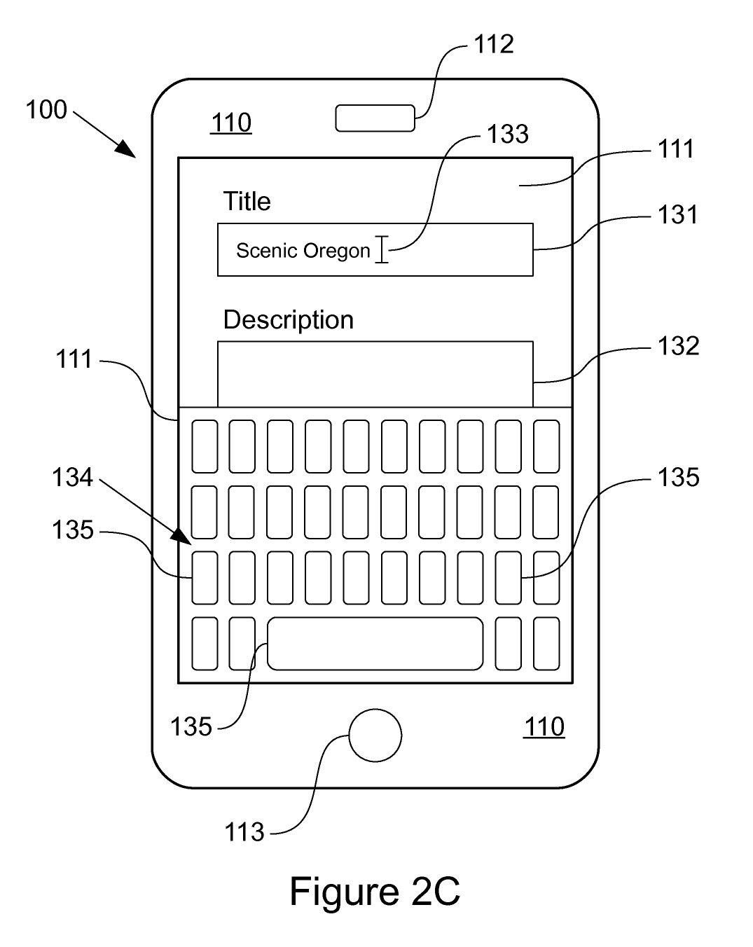

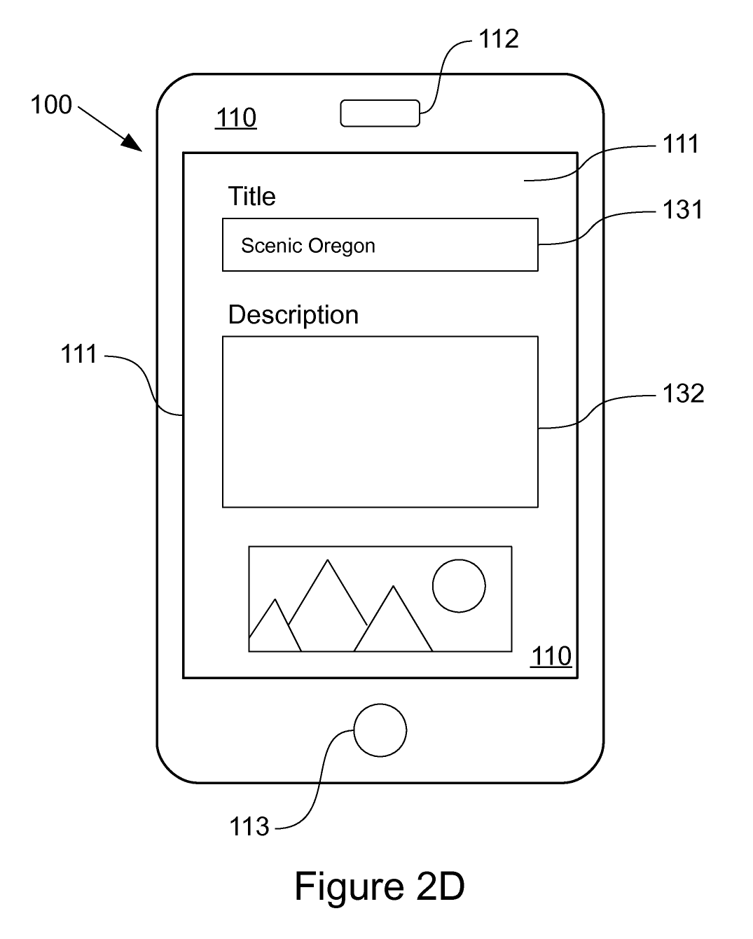

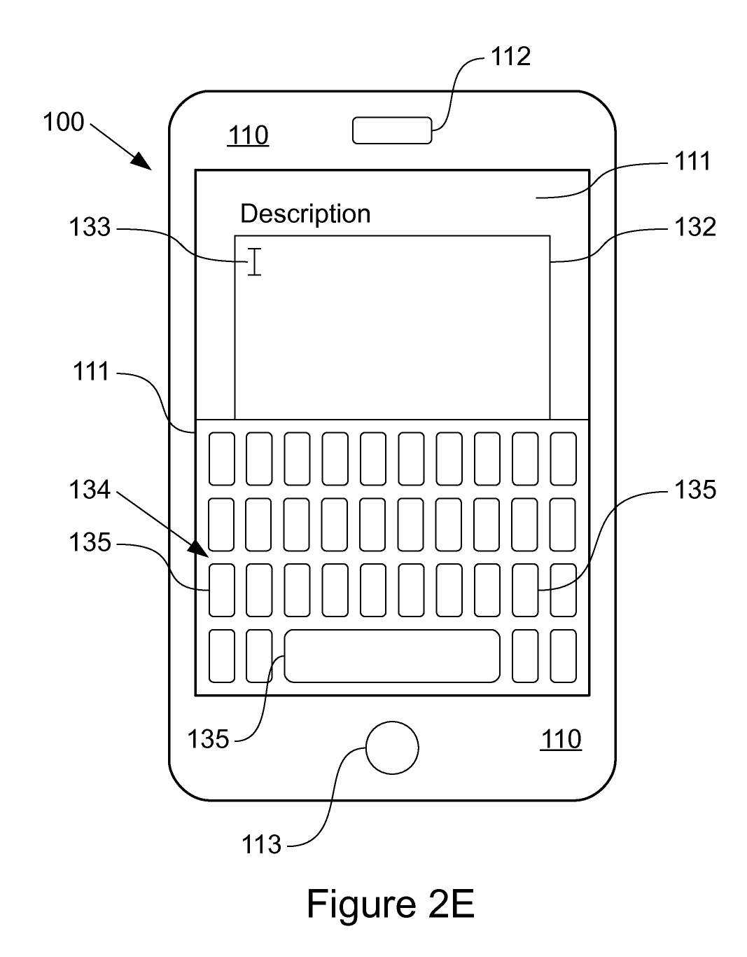

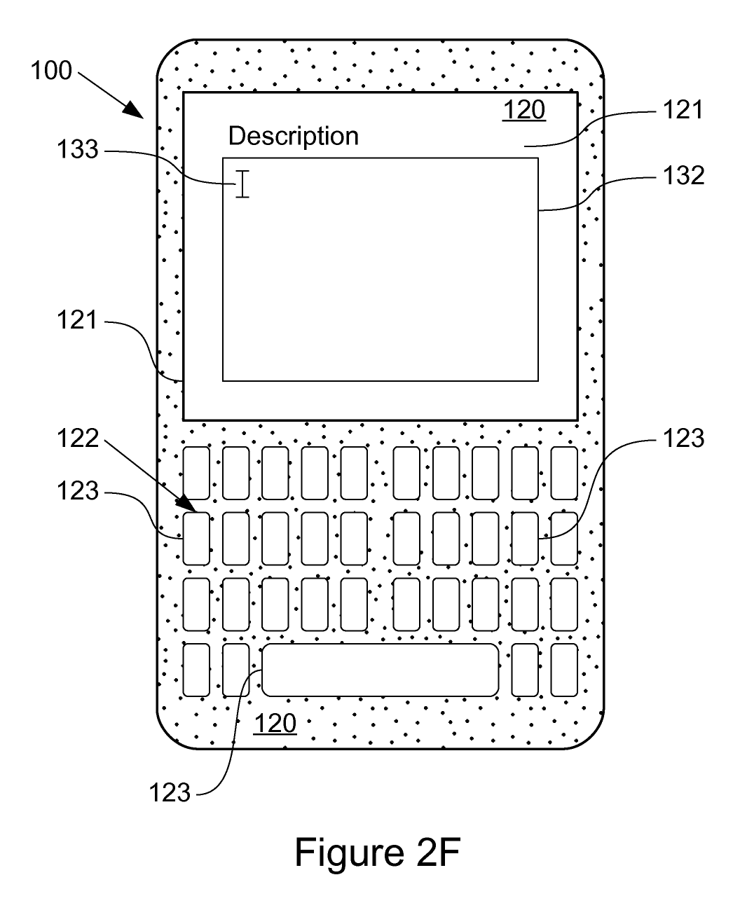

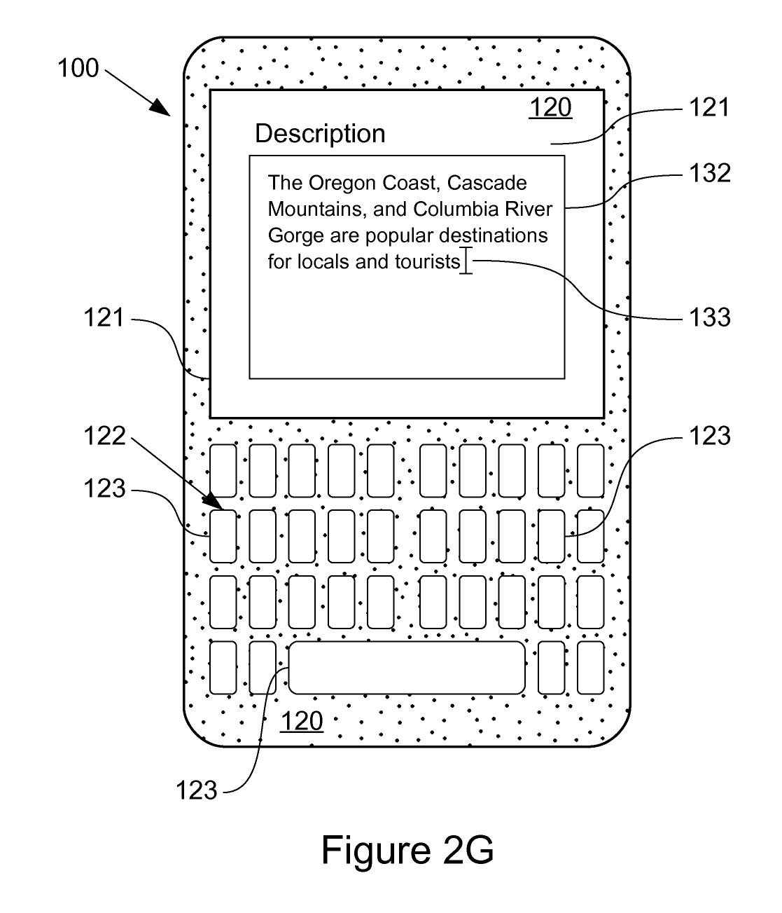

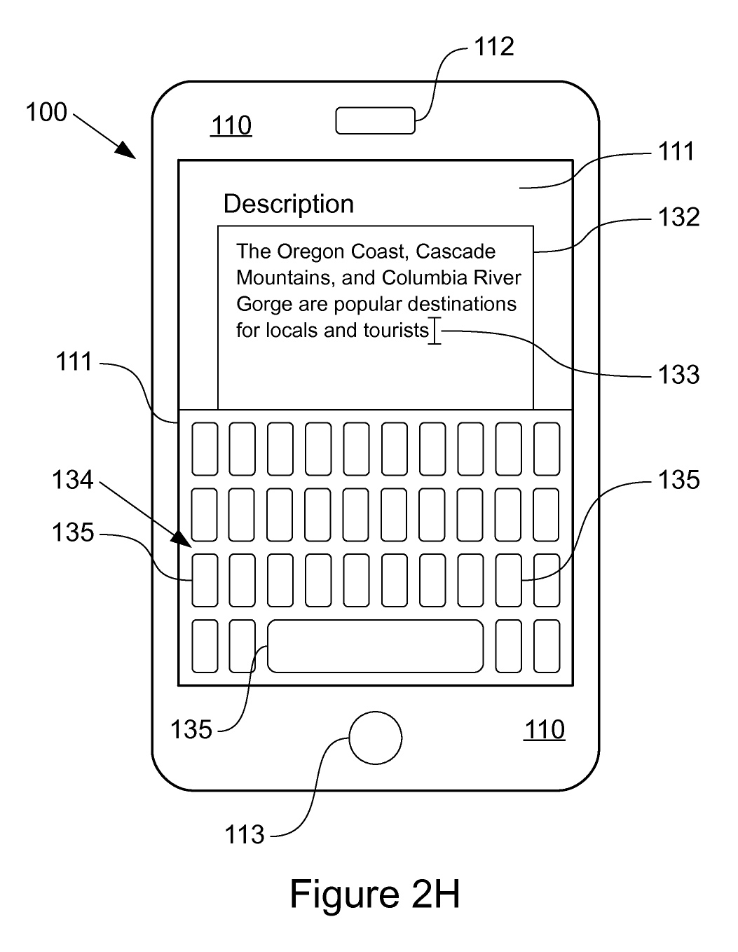

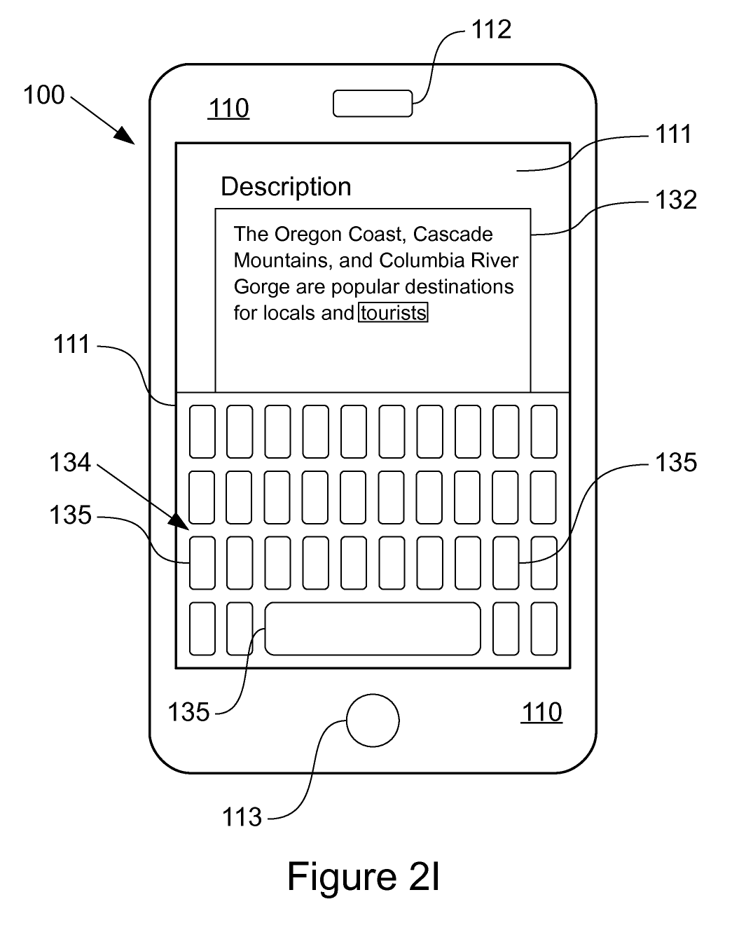

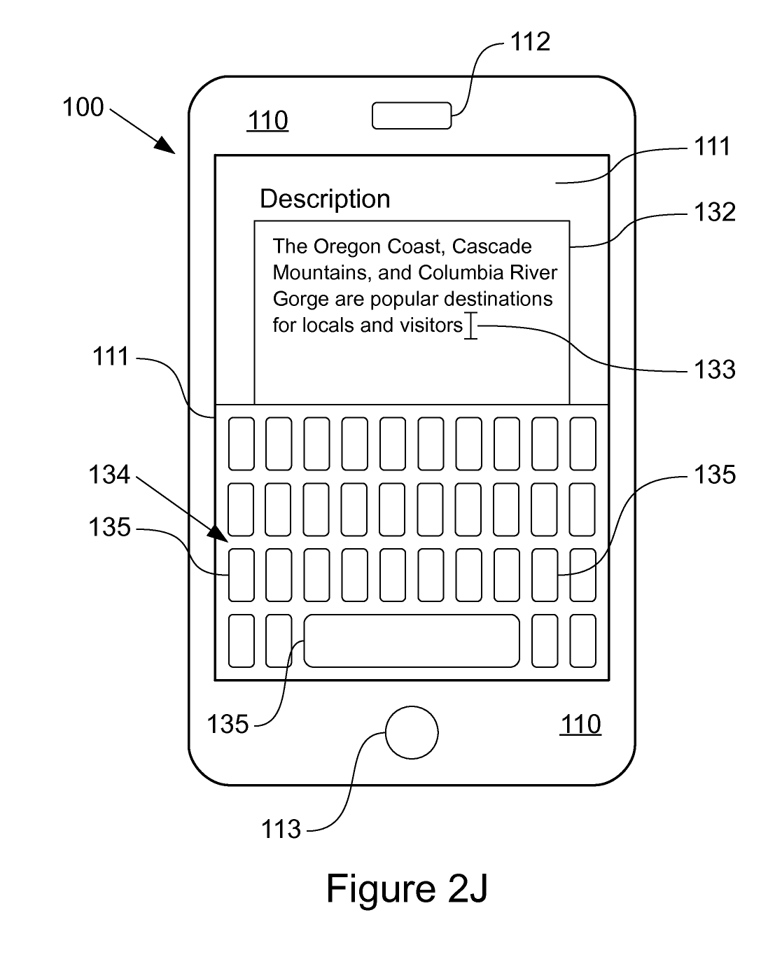

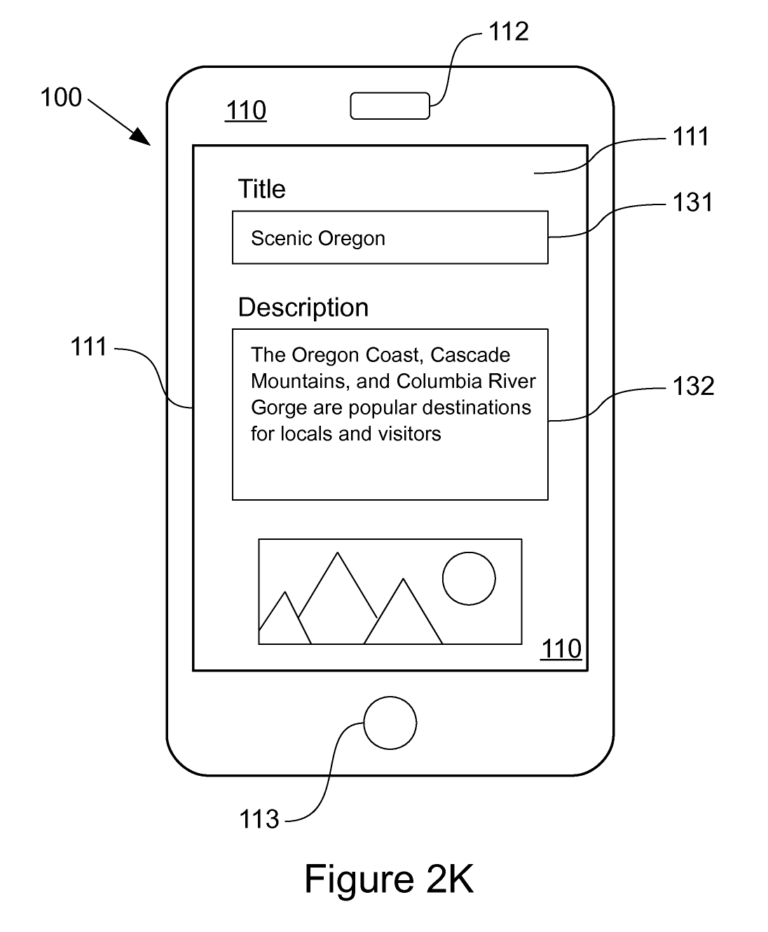

Various aspects regarding the use of portable electronic device 100 will now be discussed. As a scenario, for purposes of example, assume that the user intends to submit information about scenic places in Oregon to a web site. Referring to FIG. 2A, portable electronic device 100 displays an image of a page from the web site, which includes a first character field 131, a second character field 132, text, and a photo. The user of portable electronic device 100 will readily understand that character fields 131 and 132 are areas for entering data (e.g., text, numbers, symbols, etc.).

In order to begin entering data, the user contacts touch-sensitive display 111 at a position corresponding with the images of either of character fields 131 or 132. Assuming, for purposes of this example, that the user touches first character field 131. The image upon touch-sensitive display 111 will subsequently change to show (a) a cursor 133 within first character field 131 and (b) a virtual keyboard 134 with numerous keys 135, as depicted in FIG. 2B. By displaying cursor 133 and virtual keyboard 134, the user will recognize that data may be typed into first character field 131 with virtual keyboard 134. More particularly, the user merely contacts areas of the image on touch-sensitive display 111 that correspond with individual keys 135. Through this well-known process, the user may input characters for “Scenic Oregon” into first character field 131, as depicted in FIG. 2C. Once the data is entered, cursor 133 and virtual keyboard 134 may disappear, as shown in FIG. 2D.

At this stage in the process, the user may proceed with entering additional data into second character field 132. After the user touches an area adjacent to second character field 132, the image upon touch-sensitive display 111 will change to show (a) cursor 133 within second character field 132 and (b) virtual keyboard 134, as depicted in FIG. 2E. Additionally, second character field 132 may move or scroll toward an upper area of touch-sensitive display 111, thereby being visible adjacent to virtual keyboard 134.

Referring back to FIG. 2D, for example, first character field 131 is significantly smaller than second character field 132. In comparison with the data in first character field 131, substantially more data may be entered into second character field 132. When entering the relatively small string of characters for “Scenic Oregon” into first character field 131, the user may have opted to use virtual keyboard 134 due to preference or convenience, for example. If a larger amount of data is intended for second character field 132, the user may prefer to input the data using physical keyboard 122, possibly for the advantages of increasing input speed and receiving tactile feedback.

In order to begin entering data using physical keyboard 122, the user merely turns portable electronic device 100 over to reveal second side 120, as depicted in FIG. 2F. Whereas first side 110 faced the user previously, second side 120 faces the user at this stage in the process. Moreover, display 121 shows an image of a portion of the web page that includes second character field 132, and cursor 133 is located within second character field 132. As such, the user may enter data using (e.g., touching and depressing) the various keys 123 of physical keyboard 122. Through this well-known process, the user may input characters for “The Oregon Coast, Cascade Mountains, and Columbia River Gorge are popular destinations for locals and tourists” into second character field 132, as depicted in FIG. 2G.

Once the data is entered, the user merely turns portable electronic device 100 over again to reveal first side 110, as depicted in FIG. 2H. Note that cursor 133 remains within second character field 132 and virtual keyboard 134 continues to be displayed upon touch-sensitive display 111. As such, the data in second character field 132 may be edited or expanded using virtual keyboard 134. In this scenario, the user intends to change “tourists” to “visitors” as an edit. As depicted in FIG. 21, portions of the data may be highlighted though the touch interface to begin editing. The user then utilizes virtual keyboard 134 to make the change, as depicted in FIG. 2J. Once editing is complete, cursor 133 and virtual keyboard 134 may disappear, as shown in FIG. 2K. If the addition of further data is necessary, for example, the user may merely turn portable electronic device 100 over to reveal second side 120 and continue with data entry using aspects of the process discussed above. Similarly, the user may opt to utilize the touch interface of display 111, as well as virtual keyboard 134, for edits or additional data entry.

Based upon the above discussion, the user of portable electronic device 100 may freely switch between the use of virtual keyboard 134 and physical keyboard 122. More particularly, the user may switch between sides 110 and 120, depending upon whether a combination of (a) touch-sensitive display 111 and virtual keyboard 134 or (b) display 121 and physical keyboard 122 is intended to be used for character input. By considering preference, convenience, character input speed, and tactile feedback, the user may freely switch between the different modes for entering characters.

Additional Process Considerations

The above discussion provides an example of a process for using portable electronic device 100. Although various aspects of the process are discussed, the process is generally presented from the perspective of a user of portable electronic device 100. As such, the state of second side 120 (e.g., display 121 and physical keyboard 122) was not discussed when presenting portions of the process relating to first side 110. Similarly, the state of first side 110 (e.g., touch-sensitive display 111) was not discussed when presenting portions of the process relating to second side 120.

In portions of the process discussing FIGS. 2A-2E and 2H-2K, the user is actively utilizing first side 110. More particularly, the user is utilizing touch-sensitive display 111 for character input, editing, and other functions. Given that only touch-sensitive display 111 is being utilized during these portions of the process, second side 120 may disabled. That is, display 121 may be in a low power mode and physical keyboard 122 may be locked or deactivated. An advantage of disabling display 121, which may include dimming or turning off display 121, is to enhance the energy efficiency of portable electronic device 100 by reducing power use or battery consumption. An advantage of disabling physical keyboard 122 is to prevent inadvertent input using keys 123.

In portions of the process discussing FIGS. 2F and 2G, the user is actively utilizing second side 120. More particularly, the user is utilizing display 121 and physical keyboard 122 for character input, editing, and other functions. Given that touch-sensitive display 111 is not being utilized during these portions of the process, first side 110 may be disabled. That is, touch-sensitive display 111 may be in a low power mode and the touch-sensing capabilities of display 111 may be locked or deactivated, thereby providing the advantages of enhancing energy efficiency and preventing inadvertent input.

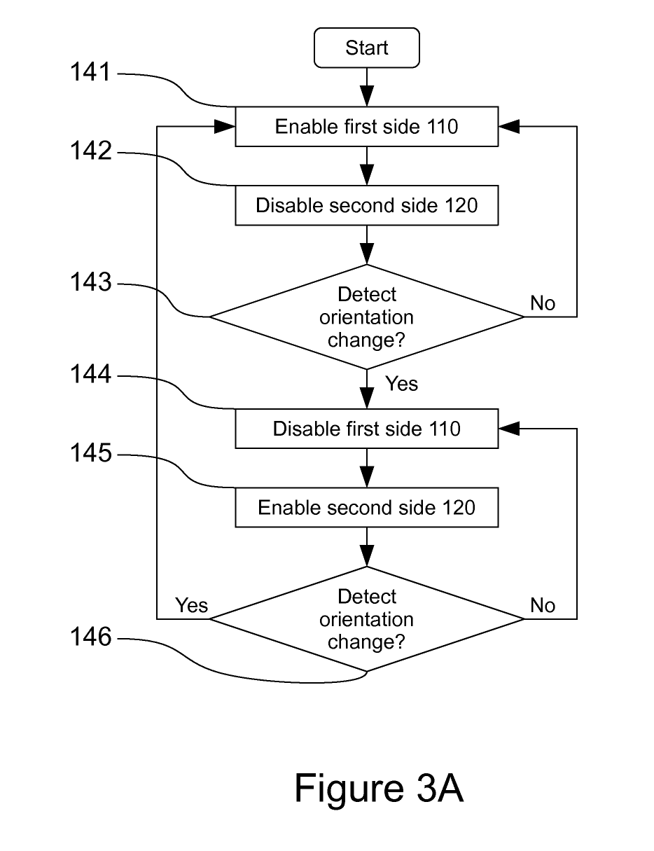

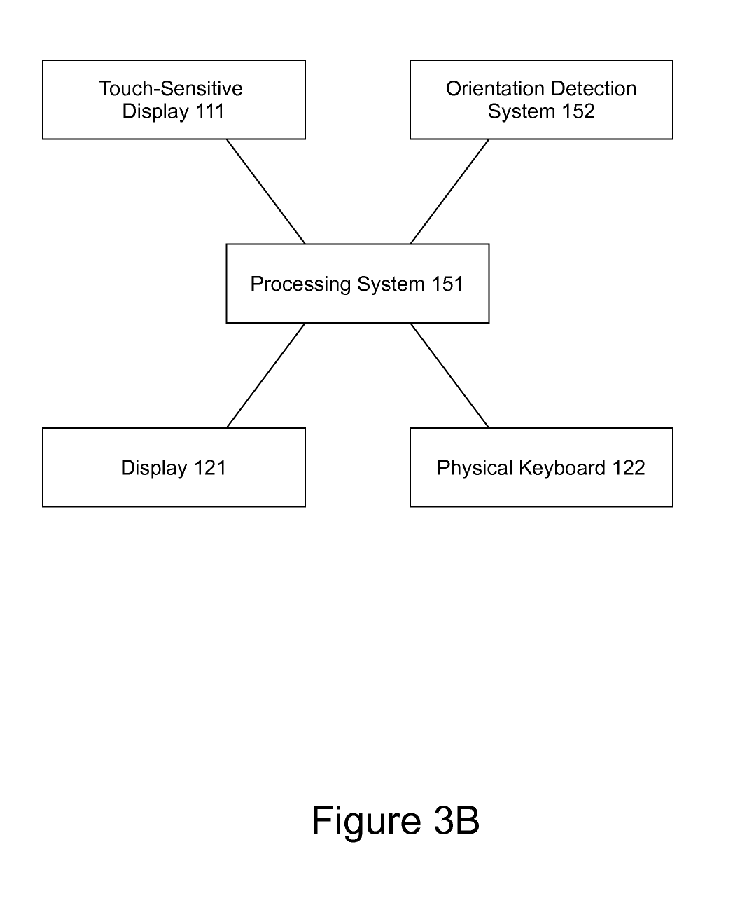

These considerations relating to the state of first side 110 and second side 120 may be better understood with reference to the flow diagram of FIG. 3A. For purposes of example, the flow diagram begins with an initial configuration wherein (a) first side 110 is enabled, as represented in step 141 and (b) second side 120 is disabled, as represented in step 142. Enabling first side 110 may include activating touch-sensitive display 100 to render an image and accept touch input. Disabling second side 120 may include deactivating or locking display 121 and physical keyboard 122. As an example, the conditions of steps 141 and 142 may be present in portions of the process discussing FIGS. 2A-2E and 2H-2K.

Portable electronic device 100 periodically or continually monitors for orientation changes, as represented in step 143. An orientation change may occur when portable electronic device 100 is turned over or rotated, as when the user is switching between the use of sides 110 and 120. If an orientation change is not detected, first side 110 remains enabled (step 141) and second side 120 remains disabled (step 142). When an orientation change is detected, however, (a) first side 110 is disabled, as represented in step 144 and (b) second side 120 is disabled, as represented in step 145. An example of a similar orientation change occurs in portions of the process discussing a transition between FIGS. 2E and 2F. Enabling second side 120 may include illuminating display 121 to render an image. In addition, enabling second side 120 may include activating or unlocking physical keyboard 122. Disabling first side 110 may include placing display 111 in the low power mode and locking or deactivating the touch-sensing capabilities of display 111. As an example, these conditions may be present in portions of the process discussing FIGS. 2F and 2G.

Once again, portable electronic device 100 periodically or continually monitors for orientation changes, as represented in step 146. If an orientation change is not detected, first side 110 remains disabled (step 144) and second side 120 remains enabled (step 145). When an orientation change is detected, however, portable electronic device 100 returns to the configuration wherein first side 110 is enabled (step 141) and second side 120 is disabled (step 142). An example of a similar orientation change occurs in portions of the process discussing a transition between FIGS. 2G and 2H.

Based upon the above discussion, the user of portable electronic device 100 may freely switch between the use of sides 110 and 120. Moreover, portable electronic device 100 detects orientation changes and alternately and oppositely disables and enables sides 110 and 120. That is, first side 110 is enabled when second side 120 is disabled, and first side 110 is disabled when second side 120 is enabled. As such, touch-sensitive display 111 and the combination of display 121 and physical keyboard 122 are alternately and oppositely disabled and enabled in response to a reorientation signal. In many configurations, the illumination of touch-sensitive display 111 and display 121 varies alternately and oppositely in response to the reorientation signal, or the illumination of touch-sensitive display 111 and the lock or unlock state of physical keyboard 122 varies alternately and oppositely in response to the reorientation signal.

Although portable electronic device 100 is discussed as alternately and oppositely disabling and enabling sides 110 and 120, various applications and functions may use aspects of sides 110 and 120 simultaneously. For example, a game application may enable physical keyboard 122 in order to permit the user to control elements rendered on touch-sensitive display 111. As another example, specific keys 135 may be enabled to move a cursor or other pointer in other types of applications rendered on touch-sensitive display 111. Accordingly, alternately and oppositely disabling and enabling sides 110 and 120 may be utilized with some applications or functions, and portions of both of sides 110 and 120 may be enabled in other applications or functions.

Further Functionality

The above discussion provides one example of a scenario in which freely switching between sides 110 and 120 may enhance character input. As another example, orienting second side 120 toward the user may launch a default application when no character field was previously active on touch-sensitive display 111. For example, the user may be viewing a photo or reading a news item on touch-sensitive display 111, and the user may then reorient portable electronic device 100 to enable display 121 and physical keyboard 122. In response, portable electronic device 100 may launch a default application, such as a text messaging application or an email application. That is, a default application may be activated on second side 120 when the user was not previously inputting text or other characters.

As another example of a scenario in which freely switching between sides 110 and 120 may enhance character input, assume that the user is continuing to input text into second character field 132 using second side 120 (i.e., display 121 and physical keyboard 122). The user may determine that additional research is necessary on a particular topic. In this scenario, the user may activate a feature that alerts portable electronic device 100 that the user intends to return to inputting text in second character field 132 on second side 120, and the user may reorient portable electronic device 100 to use side 110. The user may then utilize touch-sensitive display 111 to perform the research. When the research is complete, the user merely returns to second side 120 (i.e., reorients portable electronic device 100) and continues inputting characters in second character field 132. That is, portable electronic device 100 displays second character field 132 and its associated text on display 121, thereby permitting continued character input using physical keyboard 122.

As an extension of the scenario discussed above, assume the user intends to insert a quote or other excerpt from the research into second character field 132. If the excerpt is highlighted or otherwise selected on touch-sensitive display 111, returning to second side 120 may automatically input the excerpt into second character field 132. That is, portable electronic device may facilitate copying text from first side 110 to a character field on second side 120.

System Configuration

A general system configuration for portable electronic device 100 is depicted in FIG. 3B as including a processing system 151 that interfaces with and is coupled to each of touch-sensitive display 111, display 121, physical keyboard 122, and an orientation detection system 152. Processing system 151 may be a generally well-known structure that includes hardware (e.g., memory, processors, storage), software (e.g., operating system, application software), or a combination of hardware and software to generally control the operation of portable electronic device 100. Orientation detection system 152 may be a gyroscope or other motion sensor that detects or otherwise determines the orientation of portable electronic device 100. Given that orientation detection system 152 interfaces with and is coupled to processing system 151, data or reorientation signals from orientation detection system 152 may be utilized by processing system 151 to enable or disable touch-sensitive display 111, display 121, and physical keyboard 122. As discussed in greater detail below, orientation detection system 152 may also include cameras that determine which of sides 110 and 120 faces the user.

Based upon the above discussion, processing system 151 may control whether touch-sensitive display 111, display 121, and physical keyboard 122 are enabled or disabled based upon data or signals from orientation detection system 152. As such, processing system 151 may be responsible for alternately and oppositely disabling and enabling sides 110 and 120. More particularly, processing system 151 may be configured to (a) increase or decrease illumination of touch-sensitive display 111 and display 121, (b) activate or deactivate the touch-sensing capabilities of touch-sensitive display 111, and (c) activate or deactivate physical keyboard 122, for example.

Further Configurations and Considerations

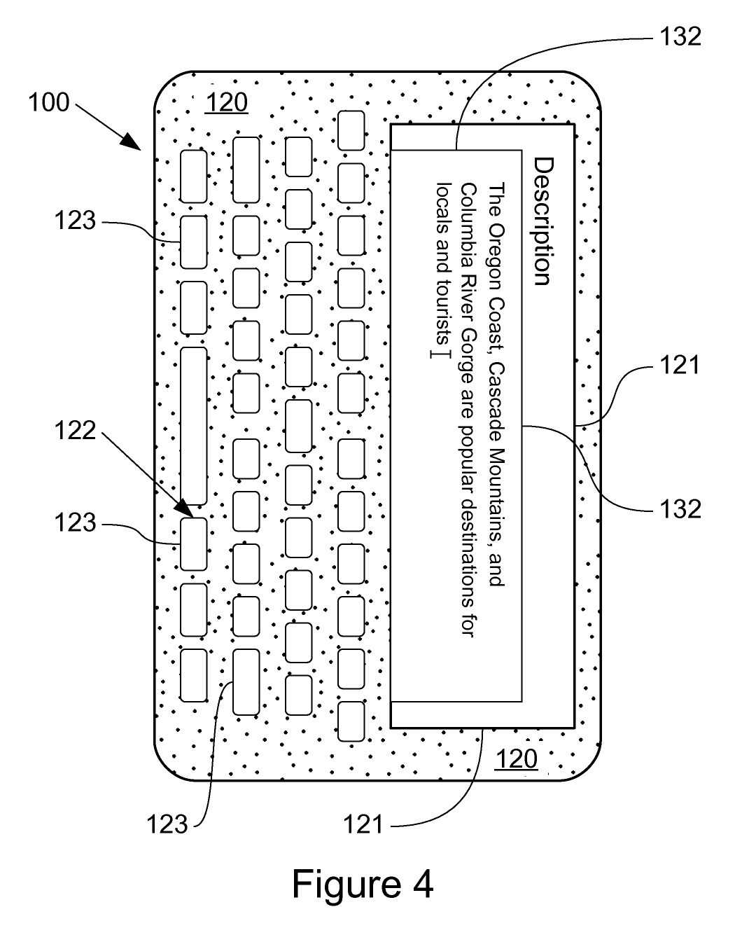

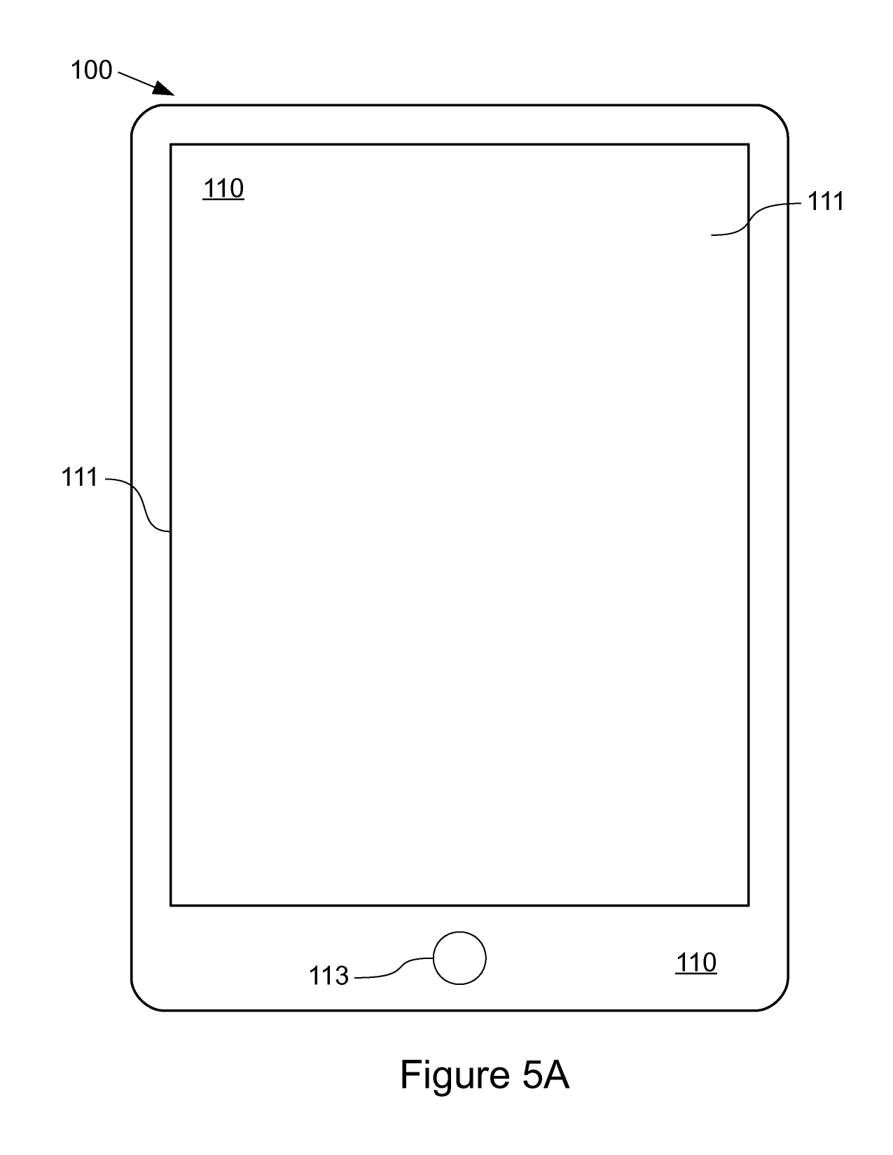

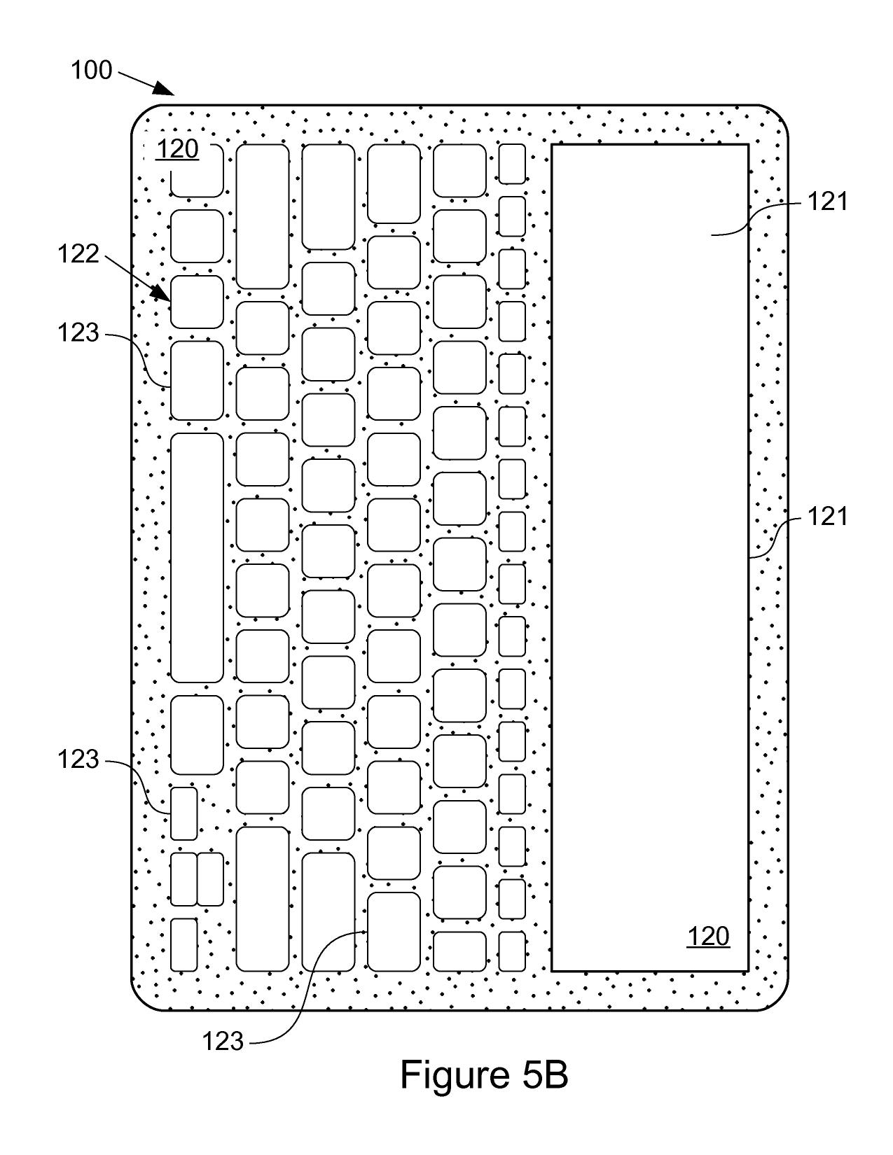

The configuration discussed above and depicted in FIGS. 1A and 1B provides a suitable example of the structure and features of portable electronic device 100. The overall structure and features of portable electronic device 100 may, however, vary considerably. Referring to FIG. 4, portable electronic device 100 is depicted as having a configuration wherein display 121 and physical keyboard 122 extend through the length of second side 120. This configuration effectively elongates each of display 121 and physical keyboard 122, which may enhance character input or permit data to be displayed differently on display 121. As another example, portable electronic device 100 is depicted as having the configuration of a tablet computer in FIGS. 5A and 5B. In comparison with a smartphone, a tablet computer may have greater length and width dimensions. As such, physical keyboard 122 is depicted as having a greater number and variety of keys 123. Moreover, the larger size of physical keyboard 122 approaches the size of a keyboard utilized in conventional desktop and notebook computers, which may impart the advantage of providing more efficient character input.

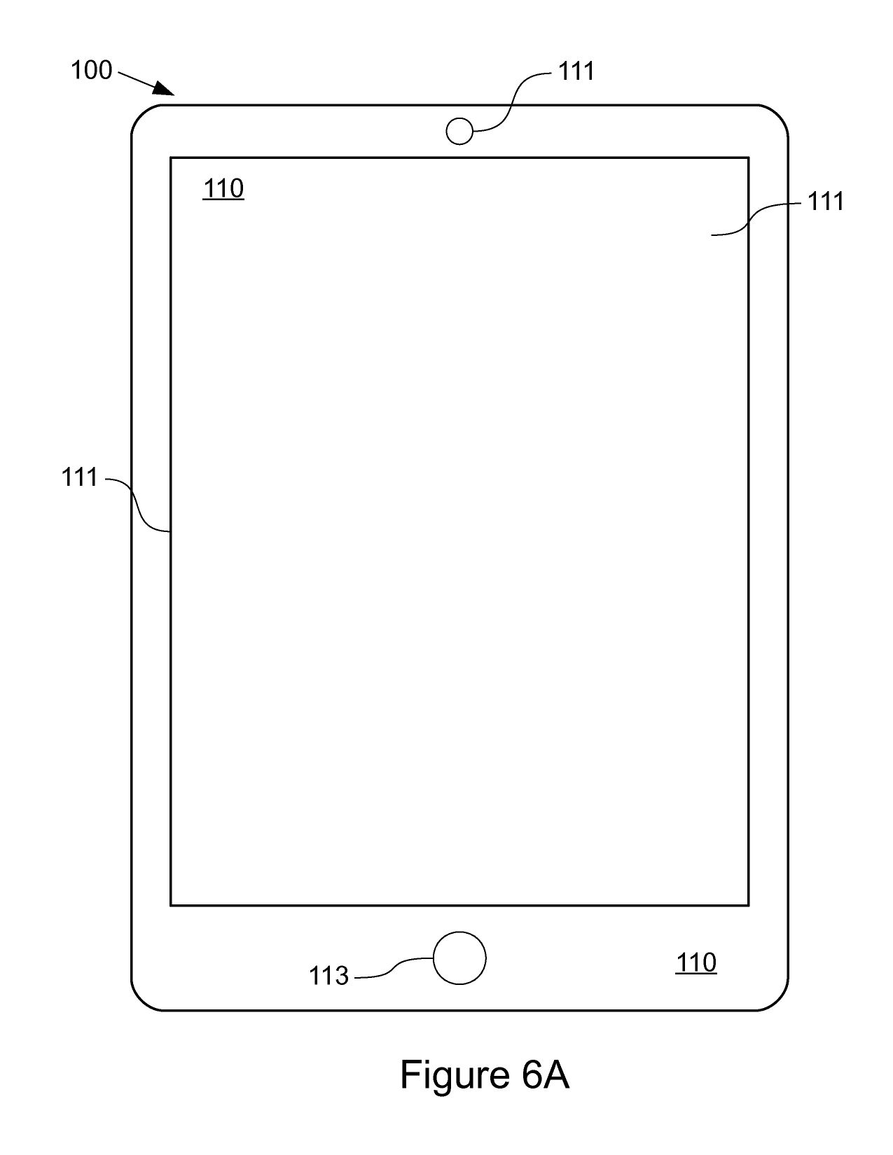

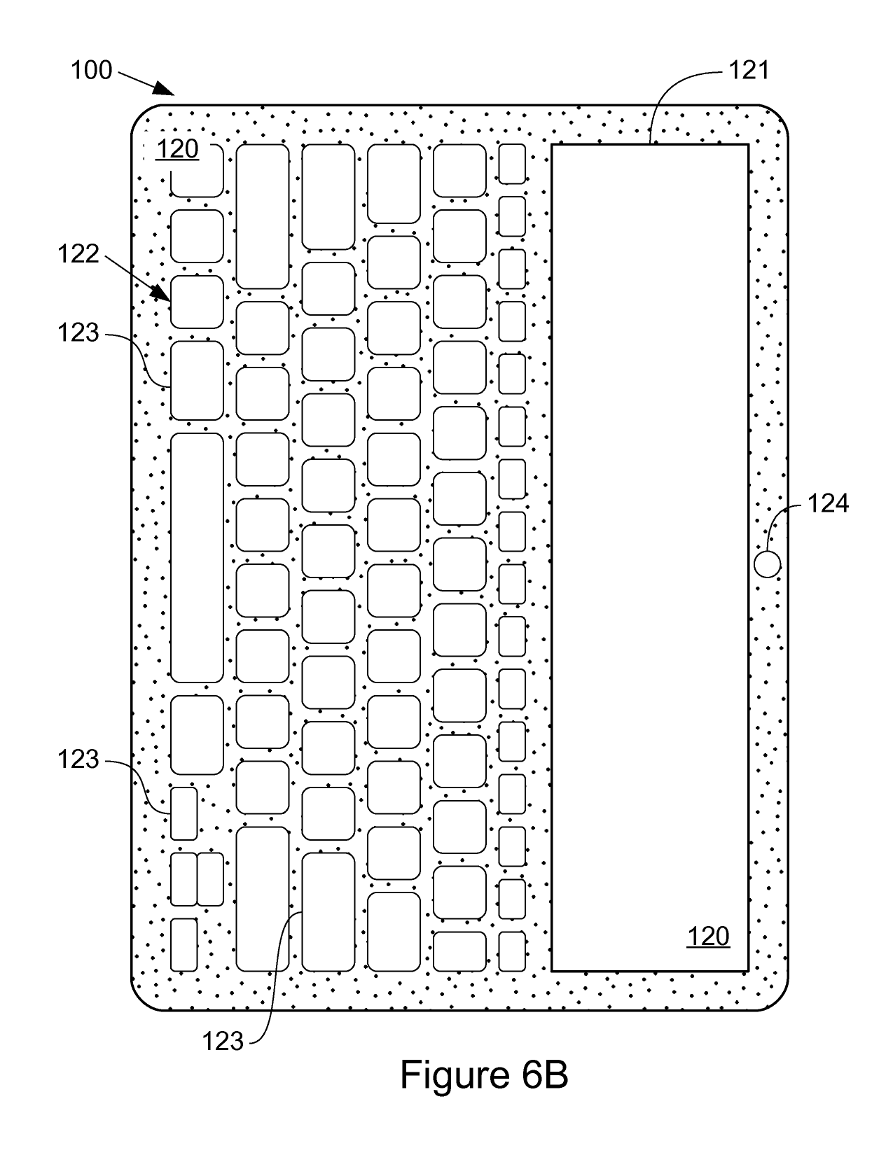

FIGS. 6A and 6B depict another configuration of portable electronic device 100. Although illustrated as a tablet computer, aspects of this configuration may be applied to smartphones or a variety of other types of portable electronic devices. In this configuration, first side 110 includes a camera 114 and second side 120 includes a camera 124. Whereas camera 114 faces outward from first side 110, camera 124 faces outward from second side 120. Cameras 114 and 124 may be incorporated into orientation detection system 152 and may be utilized to determine the orientation of portable electronic device 100 relative to the user. More particularly, processing system 151 may enable and disable sides 110 and 120 in response to data or signals from one or both of cameras 114 and 124. For example, processing system 151 may be configured to (a) increase or decrease a brightness of touch-sensitive display 111 and display 121 or (b) enable physical keyboard 122 in response to data or signals from one or both of cameras 114 and 124.

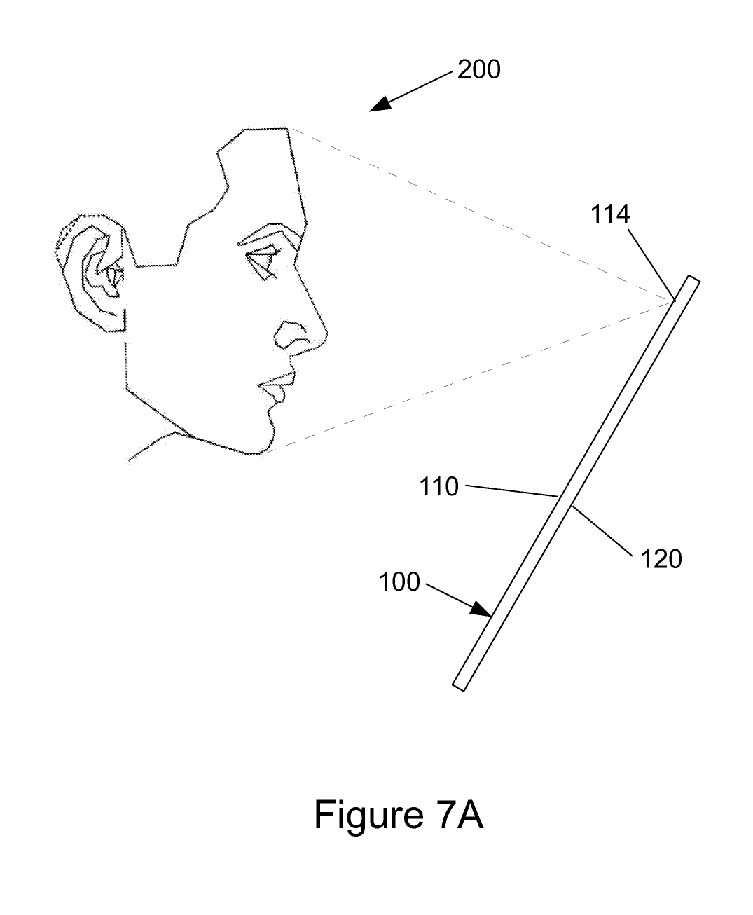

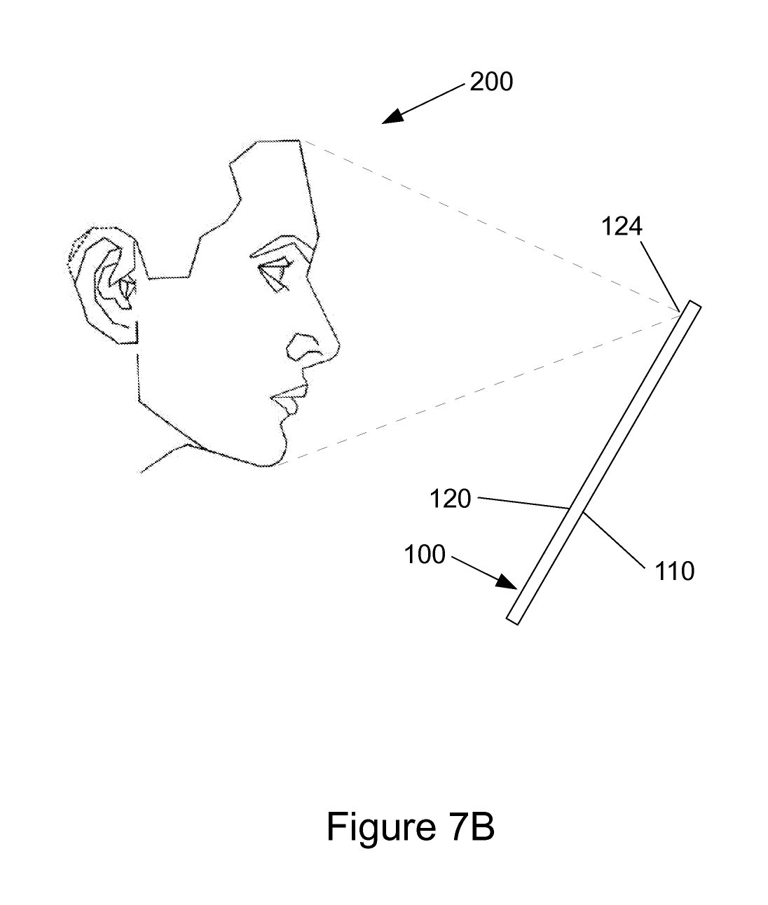

Referring to FIG. 7A, first side 110 is depicted as facing toward a user 200. In this orientation, camera 114 may be utilized to detect the presence of user 200 through facial-recognition software or other processes. Moreover, an image of user 200 captured with camera 114 may be utilized to determine the presence of user 200 as facing or being proximal to first side 110, and processing system 151 may then enable first side 110 and disable second side 120. Referring to FIG. 7B, second side 120 is depicted as facing toward user 200. In this orientation, camera 124 may be utilized to detect the presence of user 200 through the facial-recognition software or other processes. Moreover, an image of user 200 captured with camera 124 may be utilized to determine the presence of user 200 as facing or being proximal to second side 120, and processing system 151 may then disable first side 110 and enable second side 120.

The various Figures discussed above depict smartphone and tablet configurations of portable electronic device 100. In general, although not always, these configurations are unitary and substantially non-deformable. As utilized herein, “unitary and substantially non-deformable” is defined as a configuration wherein major elements of a portable electronic device (e.g., displays, keyboards) are generally fixed in position relative to each other. As such, these elements do not rotate or slide relative to each other. In portable electronic device 100, for example, the positions of touch-sensitive display 111, display 121, and physical keyboard 122 are fixed and do not rotate or slide significantly relative to each other during the normal and expected use of portable electronic device 100. In contrast, notebook computers have a mechanical hinge that separates a display from a keyboard and are not, therefore, unitary and substantially non-deformable. Some mobile phones also have keyboards that slide or rotate relative to a display and are not, therefore, unitary and substantially non-deformable.

### CONCLUSION

Based upon the above discussion, the user of portable electronic device 100 may freely switch between the use of sides 110 and 120. In the context of character input, the user may freely switch between the use of virtual keyboard 134 and physical keyboard 122, depending upon whether (a) the combination of touch input of display 111 and virtual keyboard 134 or (b) physical keyboard 122 is intended to be used for character input. By considering preference, convenience, character input speed, and tactile feedback, the user may freely switch between the different modes for entering characters. Moreover, the arrangement discussed above permits the user of portable electronic device 100 to choose between two modes for inputting characters: (a) a first mode in which a virtual keyboard is rendered on touch-sensitive display 111 or (b) a second mode utilizing physical keyboard 122. Although a majority of the above discussion relates to the manner in which character input may be accomplished, the features of sides 110 and 120 may be utilized for a variety of other purposes and may have a different functionality when performing those other purposes.

Aspects of portable electronic device 100 are disclosed above and in the accompanying Figures with reference to a variety of configurations. The purpose served by the disclosure, however, is to provide an example of the various features and concepts related to portable electronic device 100, not to limit the scope of portable electronic device 100. One skilled in the relevant art will recognize that numerous variations and modifications may be made to the configurations described above without departing from the scope of portable electronic device 100, as defined by the appended claims.

1. A portable electronic device comprising:
a first exterior side having a first display that renders a virtual keyboard; and
a second exterior side located opposite the first exterior side, the second exterior side having a second display and a physical keyboard.

2. The portable electronic device recited in claim 1, wherein the portable electronic device is one of a smartphone and a tablet computer.

3. The portable electronic device recited in claim 1, wherein the portable electronic device is unitary and substantially non-deformable.

4. The portable electronic device recited in claim 1, wherein the second display registers touch input.

5. The portable electronic device recited in claim 1, wherein the physical keyboard has at least ten keys and is located adjacent to the second display.

6. The portable electronic device recited in claim 1, wherein the physical keyboard has at least thirty-six keys.

7. The portable electronic device recited in claim 1, further including:
a processing system coupled to the first display, the second display, and the physical keyboard; and
an orientation detection system coupled to the processing system, the processing system being configured to (a) disable the first display and (b) enable the second display and physical keyboard in response to data from the orientation detection system.

8. The portable electronic device recited in claim 7, wherein the processing system is configured to decrease illumination of the first display, disable touch input of the first display, increase illumination of the second display, and enable the physical keyboard in response to the data from the orientation detection system.

9. The portable electronic device recited in claim 1, further including:
a first camera facing outward from the first exterior side;
a second camera facing outward from the second exterior side; and
a processing system configured to (a) disable the first display and (b) enable the second display and physical keyboard in response to data from the orientation detection system.

10. The portable electronic device recited in claim 9, wherein the data from at least one of the first camera and the second camera is an image of a user.

11. The portable electronic device recited in claim 9, wherein a processing system of the portable electronic device is configured to decrease illumination of the first display, disable touch input of the first display, increase illumination of the second display, and enable the physical keyboard in response to data from the orientation detection system.

12. A portable electronic device comprising:
a first exterior side having a first display that renders a virtual keyboard; and
a second exterior side located opposite the first exterior side, the second exterior side having a second display and a physical keyboard, the second display being located adjacent to the physical keyboard,
wherein the first display and the physical keyboard are alternately and oppositely enabled and disabled in response to a reorientation signal.

13. The portable electronic device recited in claim 12, wherein (a) the first display and (b) a combination of the second display and the physical keyboard are alternately and oppositely enabled and disabled in response to the reorientation signal.

14. The portable electronic device recited in claim 12, further including a motion detection system, the reorientation signal being motion data from the motion detection system.

15. The portable electronic device recited in claim 12, further including cameras facing outward from each of the first exterior side and the second exterior side, the reorientation signal being image data from at least one of the cameras.

16. The portable electronic device recited in claim 12, wherein the portable electronic device is one of a smartphone and tablet computer.

17. A method comprising:
rendering an image that includes a character field on a first display of a portable electronic device;
receiving a reorientation signal indicating an orientation change of the portable electronic device; and
responding to the reorientation signal by rendering at least a portion of the image that includes the character field on a second display of the portable electronic device, the second display being located (a) on an opposite side of the portable electronic device relative to the first display and (b) adjacent to a physical keyboard.

18. The method recited in claim 17, wherein the step of responding to the reorientation signal includes reducing illumination of the first display, disabling touch input of the first display, increasing illumination of the second display, and enabling the physical keyboard.

19. The method recited in claim 17, further including steps of:
receiving a further reorientation signal indicating another orientation change of the portable electronic device; and
responding to the further reorientation signal by increasing illumination of the first display, enabling touch input of the first display, decreasing illumination of the second display, disabling the physical keyboard, and rendering at least the portion of the image that includes the character field on the first display.

20. The method recited in claim 17, further including a step of receiving the reorientation signal from at least one of a motion sensor and a camera.
